(19) United States
(12) Patent Application Publication
(10) Pub. No.: US 2015/0039381 A1
(43) Pub. Date: Feb. 5, 2015

(54) CUSTOMER REQUEST WORKFLOW MANAGEMENT SYSTEM

(71) Applicant: BANK OF AMERICA CORPORATION, Charlotte, NC (US)

(72) Inventor: Ma. Carmela R. Coronel, Bocaue (PH)

(73) Assignee: BANK OF AMERICA CORPORATION, Charlotte, NC (US)

(21) Appl. No.: 13/954,571

(22) Filed: Jul. 30, 2013

(51) Int. Cl. G06Q 10/06; G06Q 30/00

(52) U.S. Cl. CPC G06Q 10/0633; G06Q 30/016
USPC 705/7.27

(57) ABSTRACT

Embodiments of the invention are directed to systems, methods and computer program products for enrolling for electronically generating, submitting, transmitting, or processing a request. In practice, an associate may electronically input information associated with a received customer service request. Inputting this information into an electronic system may generate a formal internal request for a particular service to be completed. Specifically, the present invention may address at least four types of services: rushing a replacement bank card to the customer; opening a processing closure account; reporting a non-working automatic teller machine; or a financial data entry system request. The formal internal request and information associated with the request may then be automatically submitted to a queue in which customer account information is masked, and the request may also be transmitted to a second user. Once the request is received by the FLM, the FLM may complete or deny the service request.

### FIELD

This application relates to the field of customer request workflow management and securing customer information throughout the workflow.

### BACKGROUND

An associate at a financial institution may receive a phone call, a chat, a message, an email, or another form of communication from a customer in regards to a needed service, including a financial data entry system (FDES) request, a Rush Card (rushing a replacement bank card to the customer) request, a request to open a processing closure (PC) account, a non-working automatic teller machine (ATM) reporting, or other like request. In turn, the associate may be required to generate a formal request and deliver the generated request to an available front line manager (FLM) at a Solution Center. Once received, the request may be appropriately addressed by the FLM.

Currently, systems for electronically transmitting a customer request, as well as the information associated with the request, may not exist or otherwise function to prevent transmitting errors or security issues. For example, after the associate receives a phone call from a customer, he (or she) may manually handwrite on a piece of paper information associated with the customer's phone conversation to generate a formal internal request. The associate may then physically walk to an available FLM's office to deliver the formal internal request to the available FLM for processing, which typically requires the associate to leave his workstation unattended. Continuation of this system not only may lead to a higher risk of human error in handwriting the request and copying information associated with the request, but may also lead to information security issues when the associate leaves his workstation unattended during the delivery of the request to the available FLM.

Financial institutions may benefit from a system for electronically transmitting a customer request, as well as information associated with a request, between the associate who receives the customer's phone call and the FLM at the Solution Center who processes the request. Specifically, an electronic transmission of the request and information associated with the request may decrease processing time, increase workflow efficiency, and reduce risk associated with human error or security issues.

### BRIEF SUMMARY

Embodiments of the invention comprise a system, computer program product, and method for electronically processing a customer request is provided. The invention comprises initiating presentation of a first interface prompting a first user to input information associated with a customer request, wherein the information associated with the customer request includes at least a portion of a customer identification number, wherein the customer identification number is associated with a customer; submitting the customer request into a queue for display to a second user, wherein the customer identification number is masked; initiating presentation of a second interface to the second user, wherein the second interface displays the information associated with the customer request, wherein the information associated with the customer request is editable; processing the customer request, wherein processing the customer request comprises at least one of executing or denying the customer request; and transmitting a first user message to the first user, in response to processing the customer request, wherein the first user message includes a status associated with the customer request.

In further accord with an embodiment of the invention the customer identification number comprises an account number associated with a financial account.

In another embodiment of the invention, the financial account comprises at least one of a checking account, a savings account, or an investment account.

In still another embodiment of the invention the customer request comprises at least one of a request for a replacement bank card, a request for opening a processing closure (PC) account, a report on a non-working automatic teller machine (ATM), or a financial data entry system (FDES) request.

In yet another embodiment of the invention, the portion of the customer identification number includes the last four digits of the customer identification number.

In further accord with an embodiment of the invention the first user is an associate associated with the entity.

In another embodiment of the invention, the second user is a front line manager (FLM) associated with the entity.

In still another embodiment of the invention, the queue distributes the customer request to a next available front line manager (FLM).

In yet another embodiment of the invention, the customer identification number is masked by replacing each digit of the customer identification number with a zero.

In further accord with an embodiment of the invention, processing the customer request comprises generating a record of the customer request as well as information associated with the customer request.

In another embodiment of the invention in addition to submitting the customer request into the queue, the module executable by the processor is further configured to generate and transmit a second user message to a second apparatus associated with the second user, wherein the second user message includes at least one of an associate name, a front line manager (FLM) name, a request type, a date and time of submission, a request identification number, or instructions associated with processing the customer request.

In still another embodiment of the invention, transmitting the first user message to the first user comprises generating and transmitting the first user message, wherein the first user message includes at least one of an associate name, a front line manager (FLM) name, a request type, a date and time of submission, a request identification number, a reason for denial, or instructions associated with processing the customer request.

In yet another embodiment the invention further comprises a portal that enables users to access, view, edit, modify, delete, add, append, store, save, upload, download, and share information associated with the customer request.

In another embodiment of the invention, user authentication is required to access the portal.

In further accord with an embodiment of the invention the customer request further comprises tracking the customer request and providing analytics based on processing the customer request.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, where:

FIG. 1 is a general process flow for processing a customer request, in accordance with embodiments of the present invention;

FIG. 2 is a user interface for submitting a new request, in accordance with embodiments of the present invention;

FIG. 3A is a queue user interface for viewing the in process requests, in accordance with embodiments of the present invention;

FIG. 3B is a message for transmitting a new request, in accordance with embodiments of the present invention;

FIG. 4 is a user interface for editing a request, in accordance with embodiments of the present invention;

FIG. 5 is a message for confirming the request has been completed, in accordance with embodiments of the present invention;

FIG. 6A is a message for confirming the request has been denied, in accordance with embodiments of the present invention;

FIG. 6B is a tracking user interface illustrating the requests that have been modified by users, in accordance with embodiments of the present invention; and

FIG. 7 is a system diagram for executing the present invention, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, an “entity” as used herein may be a financial institution or other like entity. For the purposes of this invention, a “financial institution” may be defined as any organization, business, or other like entity in the business of moving, investing, or lending money, dealing in financial instruments, or providing financial services. This may include commercial banks, thrifts, federal and state savings banks, savings and loan associations, credit unions, investment companies, insurance companies and the like. An “account” may be a relationship that the customer has with the entity. Examples of accounts include a deposit account, such as a transactional account (e.g. a banking account), a savings account, an investment account, a money market account, a time deposit, a demand deposit, a pre-paid account, a credit account, a non-monetary user profile that includes only personal information associated with the user, or the like. The account is associated with and/or maintained by an entity, such as the financial institution or other third-party entity.

In some embodiments, the user described in the present invention may include an associate, a front line manager (FLM), an agent, an account manager, or a customer service representative associated with the entity, an IT technician, a mainframe operator, or the like.

The present invention comprises a system for electronically generating, submitting, transmitting, and/or processing a request. In practice, the user (e.g., an associate) may electronically input information associated with a received customer service request. Inputting this information into an electronic system may generate a formal internal request for a particular service to be completed. Specifically, the present invention may address at least four types of services: rushing a replacement bank card to the customer (e.g., when a debit card, a credit card, or the like has been lost or misappropriated by another person); opening a processing closure (PC) account; reporting a non-working automatic teller machine (ATM); or a financial data entry system (FDES) request. The formal internal request and information associated with the request may then be automatically transmitted to a second user (e.g., an available FLM at the Solution Center). Once the request is received by the FLM, the FLM may complete or deny the service request. The FLM may transmit a message (a notification, an email, an alert, or the like) to the associate who generated the request in response to determining if the request has been completed or denied. Ultimately, the purpose of the present invention may be to reduce processing time of the request while minimizing potential issues that may arise with manually processing the request.

The present invention may be configured to automatically create or store a record of each request, as well as information associated with the request. Information associated with the request may include contact information, account information, an identification number, a request type, a request number, a name or identification number associated with an associate or an FLM, a date, a status, a turnaround time, notes or comments, an address, the last four digits of the customer's card, or the like.

The present invention may include a secure portal or platform for generating and/or transmitting the request. A secure log in or sign in may be required for the associate or the FLM to access the information associated with the request. Providing additional security authentication, such as a password, a passcode, a personal identification number (PIN), an answer to a security question, or the like maybe required for user access.

Upon being granted access to the portal, the user (e.g., the associate who generates the request or the FLM who processed the request) may view, edit, modify, add, delete, change, or append information or data associated with the request. Uniquely, the portal may automatically mask non-public information associated with the request (e.g., replace numerical digits with a character, typically a zero, dashes, Xs, or other like characters). Masking information associated with the request may ensure that the information cannot be seen, read, stolen, or misused by another user. Information that is “masked” (e.g., “zeroed”) may include but is not limited to the customer's name, address, alternative address for a replacement card, the customer's card number or account number, the last four digits of the customer's card number or account number, or another numerical data point. The purpose of masking information may be to reduce the risk of identity misappropriation.

In some embodiments, the true value of the information may be revealed upon clicking the masked information. For example, when a customer's request record is retrieved by the user for viewing, the customer ID may appear as all zeroes. When the associate clicks the customer's ID, the masking may disappear, thus displaying the true value of the customer's ID. In other embodiments, only a portion of the information may be shown initially (which may be masked or unmasked) and clicking the information may display the true value of the information.

The information associated with the request may also be accessible via an external hard drive, database, cloud storage, or the like. For example, information associated with the request may be stored on a server, either associated with the entity or a third party. Access to the information may be restricted by security measures similar to those mentioned above, including but not limited to user input of a password, a passcode, a username, an answer to a security question, a PIN, or the like. In alternative embodiments, the information associated with the request may be stored in another memory location as a backup file.

The present invention may further be configured to track each request. By tracking each request, the present invention may analyze the information associated with each request to determine which types of requests, processing methods, or other pieces of information are critical to workflow efficiency. Furthermore, the present invention may be configured to learn, understand, and/or analyze the customer's request history. An understanding of the customer's request history may enable the present invention to prefill information associated with the customer's account on new requests, recognize patterns associated with the customer's requests (and therefore anticipate a future request type), or shed light onto other points of interest associated with processing requests.

To track each request, the present invention may associate a counter with the request or the information associated with the request. Through the use counters, the present invention may determine a wide variety of useful data points. For example, the present invention may determine how many types of requests are received either in total or on a per-customer basis. The present invention may also analyze this information and provide analytics to the user to help increase customer satisfaction and drive process efficiency.

In operation, the associate may receive a phone call, a chat, a message, an email, a notification, or other form of communication from the customer. In response to receiving the communication, the associate may generate and/or submit a new customer request using a new request form. The new request form may include information fields for the associate to input information associated with the request. Typically, the associate inputs at least one of a type of request to be generated, a party identification number (an ID number that may be associated with the customer or the customer account), customer contact information, the last four digits of a card or an account number, an address of a non-working ATM, the name of an available FLM, comments or reasons for the request, or the like. Information may be inputted via a text field, a drop down menu, a selection, prefilled by the present invention, or via another method. In some embodiments, the present invention may prefill information associated with the new request based on a customer's request history or records.

Once complete, the associate may submit and transmit the request to a queue for the next available FLM. The submitted request may embody an email, a notification, a pop-up message, a text message, or the like and may include a request number or ID, a request type, a date of submission, or other information. In some embodiments, information associated with the request may be edited, shortened, masked by zeroes (or another character), or modified in another way before being presented to the next available FLM for processing. For example, only the last four digits of the customer's card, identification number, or account number may be visible.

Once the request has been submitted and transmitted to the queue for the next available FLM, the request may be presented to the next available FLM for processing. Processing the request may include a variety of steps to appropriately address the request. For example, if the associate submits a Rush Card request, the FLM in response may issue a new card to the customer. Issuing a card to the customer may include linking the customer's account information to a new card, canceling an old card, printing a new card, shipping a new card, or the like. In some embodiments, the FLM may also edit the information associated with the request.

Upon completion of processing the request, the FLM may transmit to the associate who generated and submitted the request a message including a status, a completed date and time, a request type, a request number or ID, or another piece of information, instructions of how to proceed, or the like. The message may also include whether or not the request was completed or denied. If the request was denied, the message may include comments or reasons as to why the request was denied. The associate may then use the information included in the message to inform the customer of the next steps associated with completing the requested service.

Additionally, a message may be transmitted to the customer. The message may include information associated with a request. For example, the message may include a status or turnaround time for processing the request, a tracking number, or the like. The message may also include a link, thereby linking the user to access to the request.

The present invention may be configured to remove, delete, or mask customer information that is security-sensitive, such as a customer name or address, an alternative address, the last four digits of an account number, a card number, contact information, or other information, from the customer's request record. In some embodiments, only the customer ID and notes associated with the request may remain in the request record for archival purposes. The customer ID may be linked to one or more requests, customer accounts, or the like. In other embodiments, other combinations of information may be kept in the record, and some information may be masked.

Providing associates and FLMs with an electronic method of submitting and transmitting requests may reduce request processing time by nearly fifty percent, or more or less. Reduced request processing time may increase customer satisfaction and workflow efficiency. Furthermore, masking information in the system may help reduce issues associated with identity misappropriation while respecting the privacy of customers. The present invention may save a wealth of request processing time, improve security, and provide a deeper understanding of customers' request habits.

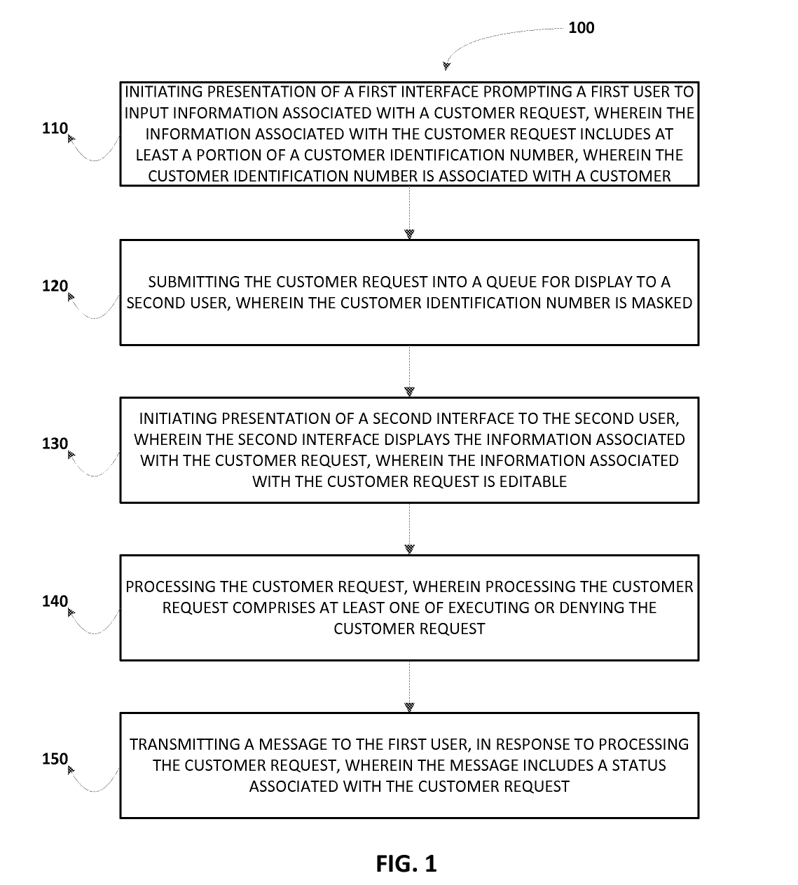

FIG. 1 illustrates a customer request process flow 100 for electronically processing a customer request. At block 110, the process includes initiating presentation of a first interface prompting a first user to input information associated with a customer request, wherein the information associated with the customer request includes at least a portion of a customer identification number, wherein the customer identification number is associated with a customer. At block 120, the process includes submitting the customer request into a queue for display in a list of customer requests, wherein the customer identification number is masked. At block 130, the process includes initiating presentation of a second interface, wherein the second interface displays the information associated with the customer request, wherein the information associated with the customer request is editable. At block 140, the process includes processing the customer request, wherein processing the customer request comprises at least one of executing or denying the customer request. At block 150, the process includes transmitting a message to the first user, in response to processing the customer request, wherein the message includes a status (e.g., completed or denied) associated with the customer request.

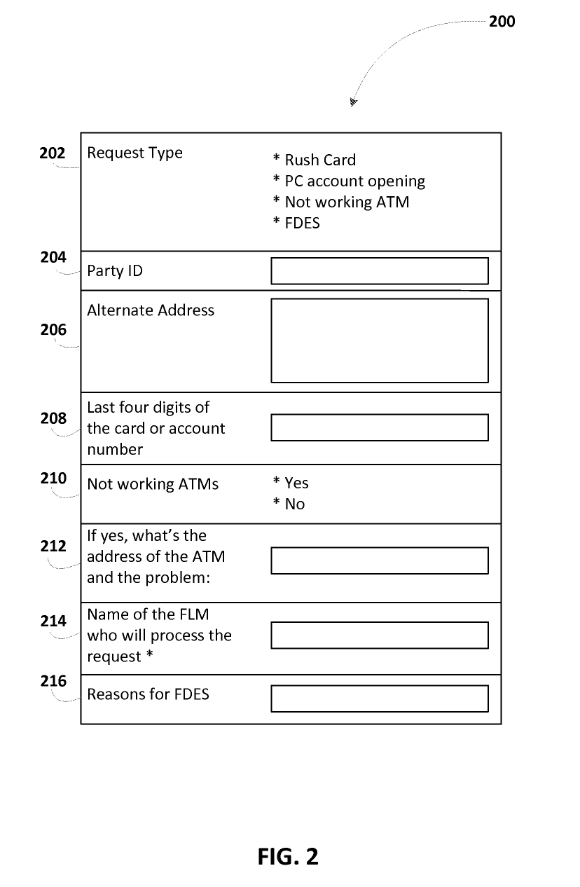

FIG. 2 illustrates a new request interface 200 for submitting a new request. The new request interface 200 in FIG. 2 may be presented to the associate once the associate has been granted access into the request portal. The new request interface 200 may include fields for the associate to input information associated with the request, including but not limited to: a request type 202, wherein the request type 202 is at least one of a Rush Card, opening a PC account, a not working ATM information, or an FDES request; a party identification (ID) 204, wherein the party ID 204 is a string of eleven digits; an alternate address 206, a phone number, or other contact information; a card or an account number 208, or portions of a card or account number (e.g., only the last four digits of the number); a selection if the ATM is working 210, as well as an address of the non-working ATM 212; a name of the FLM 214 who will process the request, wherein the name is input via text or selected from a drop-down menu or a search; and reasons or comments associated with an FDES request 216; or other information. In some embodiments, the information fields may require a selection, a text input, a numerical input, a search, or may be prefilled with information automatically.

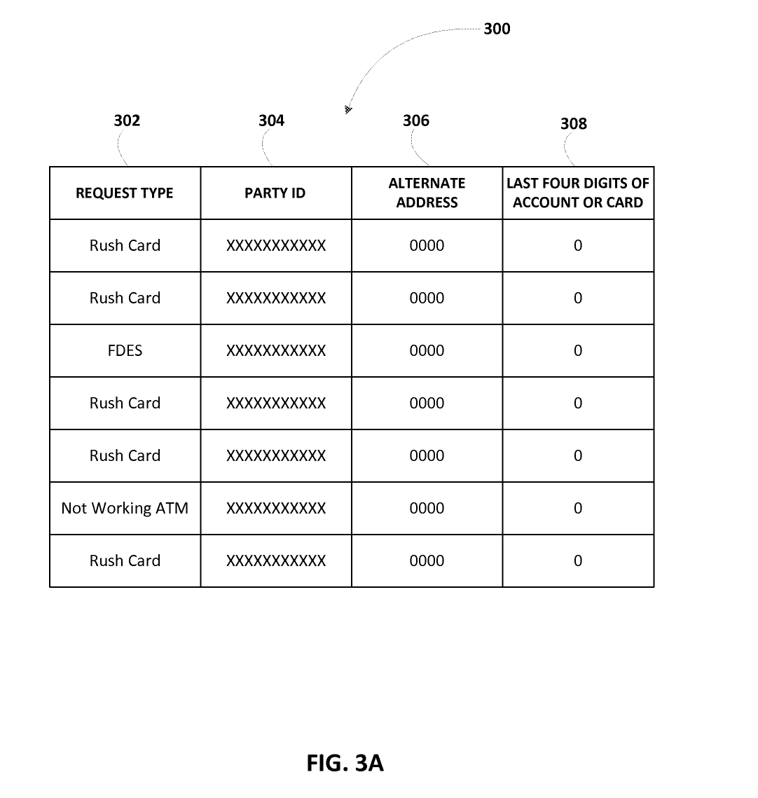

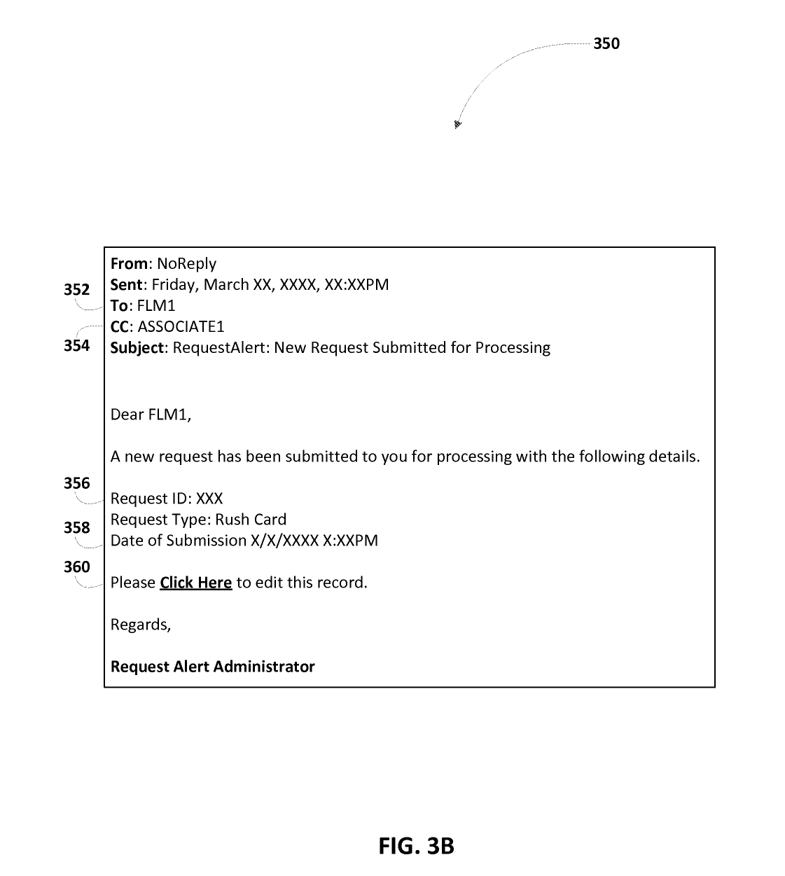

After the user fills out the fields for submitting a new request in the new request interface 200, the request may be included in queue user interface 300. As previously indicated, in one embodiment of the invention the queue user interface 300 displays some information about the customer and the customer request, and masks other information about the customer, such as for example, the customer account number. In the embodiment illustrated in FIG. 3A the queue user interface 300 illustrates columns listing the request type 302, the party ID 304, an alternate address 306, and the last four digits of the customer number 308. However, as illustrated in FIG. 3A the queue user interface 300 may mask the alternate address 306 for the customer as well as the last four digits of the customer's account 308, while displaying the actual request type along with the party ID number 304 (e.g., illustrated as “Xs” but would be displayed as number, letters, characters, or combinations therefore) in the queue user interface 300. The request type provides the type of request from the customer, while the party ID is an identification number assigned to a customer that is unrelated to a specific customer account number. Therefore, while the party identification may identify a particular customer it is not associated with a specific account number of the customer. The alternate address and the customer's account information (e.g., last for digits of the account number) are kept hidden so as to avoid any misappropriation of the customer account information. In the illustrated embodiments, the information is masked out with “0's;” however, any other type of masking elements may be utilized (e.g., characters, letters, or the like, such as “- - - ,” or the like).

In some embodiments the elements that are masked may only be masked based on the level of access assigned to a user. For example, the FLM may be able to see the last four digits of the customer account number in the queue user interface when the FLM is logged into the application, but the last four digits of the customer account number may not be displayed to an associate looking at the same queue user interface 300 when the associate is logged into the application.

In some embodiments of the invention along with the request being captured in a queue, a notification message may also be transmitted to the FLM when a customer request is completed by an associate. FIG. 3B illustrates a FLM message 350 transmitted from the associate to the available FLM in regards to a newly submitted request. Included in the message may be: a name of the FLM 352 who will process the request; a name of the associate who initiated the request 354; a request identification number (ID) 356; a request type; a date of submission 358; a link 360 that enables the FLM to edit the information associated with the request; or additional information.

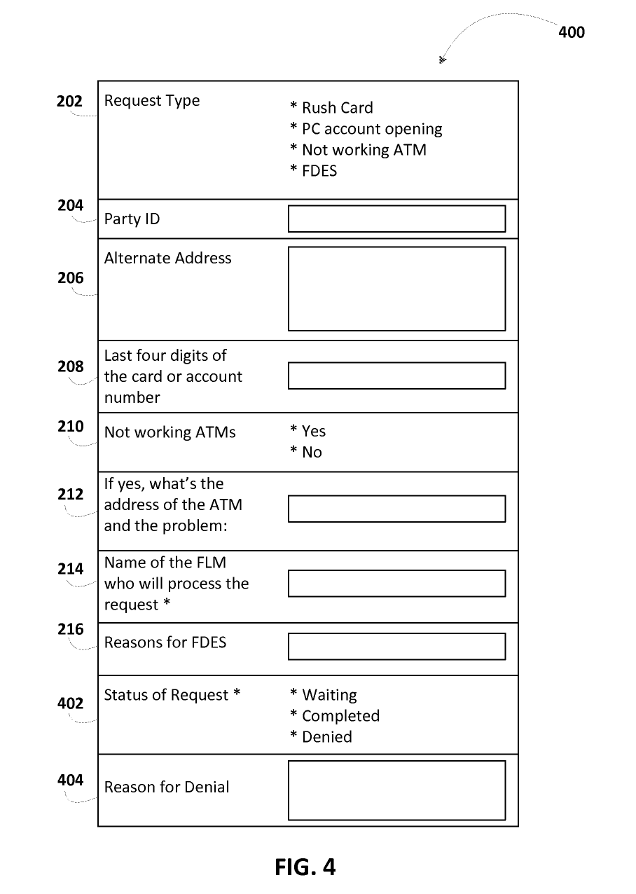

Clicking the link may direct the FLM directly to the customer request interface 400 as displayed in FIG. 4, which enables the FLM to edit the information associated with the customer request. In other embodiments the link may direct the FLM to the queue user interface 300 and the FLM may select the appropriate customer request. In some embodiments, the customer request interface 400 may be prefilled with the information associated with the customer request. In other embodiments, the customer request interface 400 may require additional input. In addition to including the fields of information found in the user interface illustrated in FIG. 2 for associate use, the FLM's form in FIG. 4 may further include: a status of request 402, wherein the status may be selected between “Waiting,” “Completed,” or “Denied,” or other like status; reasons or comments for denial 404; or other information.

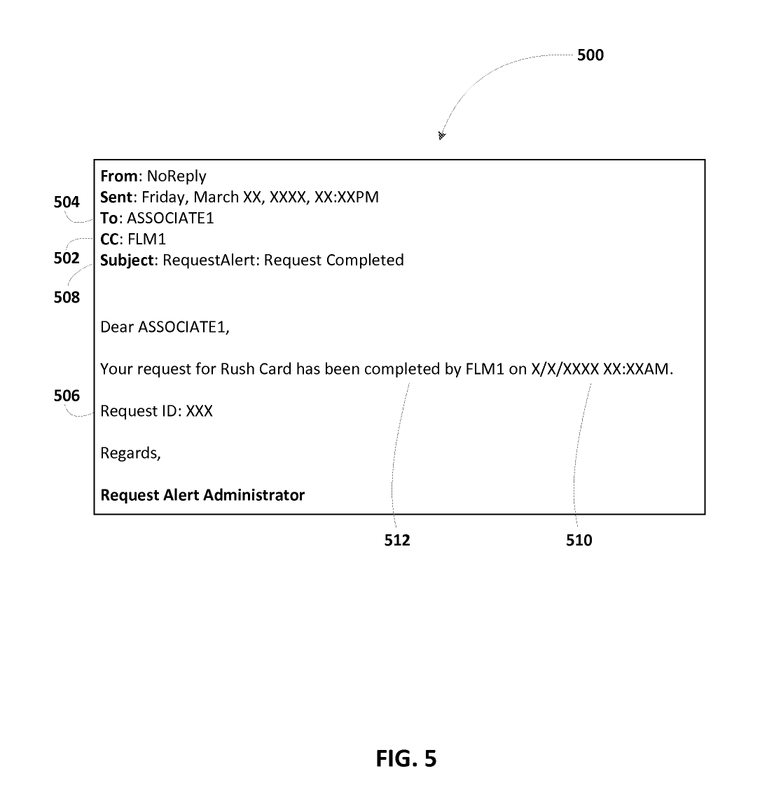

FIG. 5 is an associate message 500 transmitted from the FLM to the associate that confirms the completed status of the customer request. Included in the message may be: a name of the FLM 502 who will process the request; a name of the associate 504 who initiated the request; a request identification number (ID) 506; a request type 508; a date of submission 510; a status associated with the request 512; or additional information.

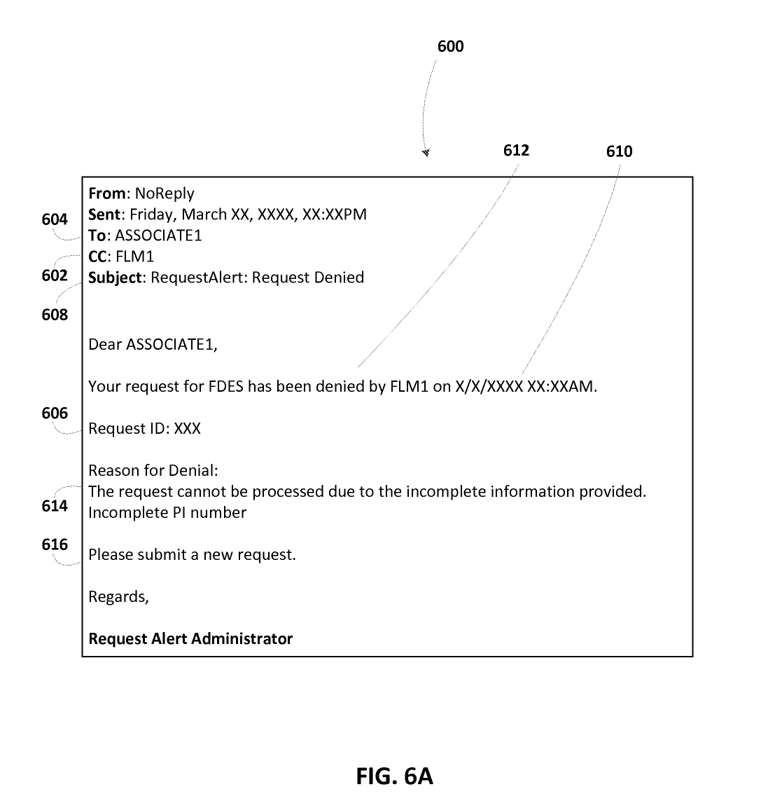

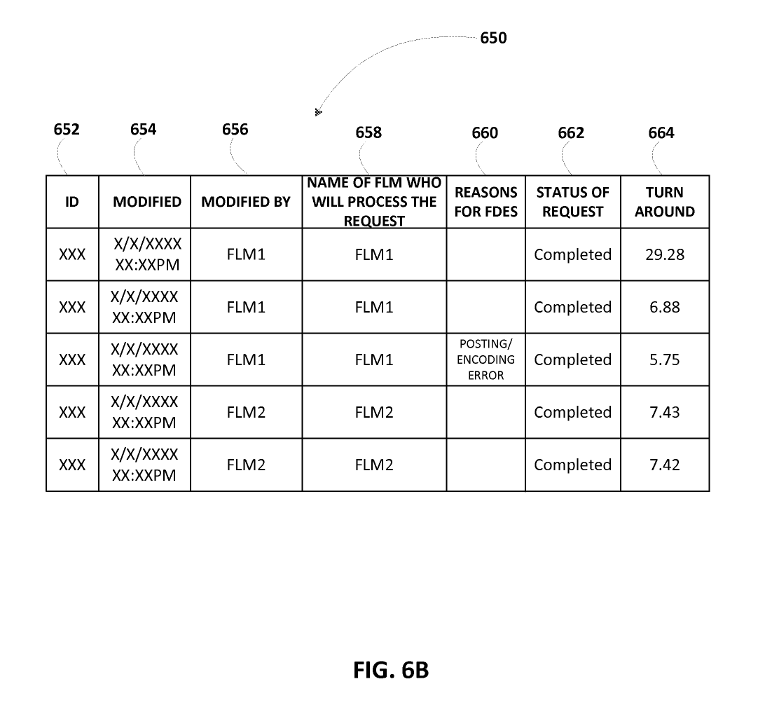

FIG. 6A is an associate message 600 transmitted from the FLM to the associate that confirms the denied status of the request. Included in the message may be: a name of the FLM 602 who will process the request; a name of the associate 604 who initiated the request; a request identification number (ID) 606; a request type 608; a date of submission 610; a status associated with the request 612; a reason or comments for denial 614; instructions or suggestions for submitting a new request 616; or additional information.

FIG. 6B illustrates a tracking user interface 650 that allows a user to track the progress of particular request and/or determine analytics related to processing requests. As illustrated in FIG. 6 B in one embodiment the tracking user interface 650 includes the ID number of the request 652, the modified date and time 654, the user 656 that made modifications to the request, the name of the FML 658 on duty that is responsible for processing the request, reasons the request was completed or denied 660, a status of the completion of the request 662, and the amount of time it took for the request to be completed (e.g., turn-around time 664). The tracking user interface 650 may also allow for other information or drill down into the specific aspects of a request. For example, the user may select one of the customer requests in the tracking user interface 650 and view additional information about the customer requests and edits made to the customer requests.

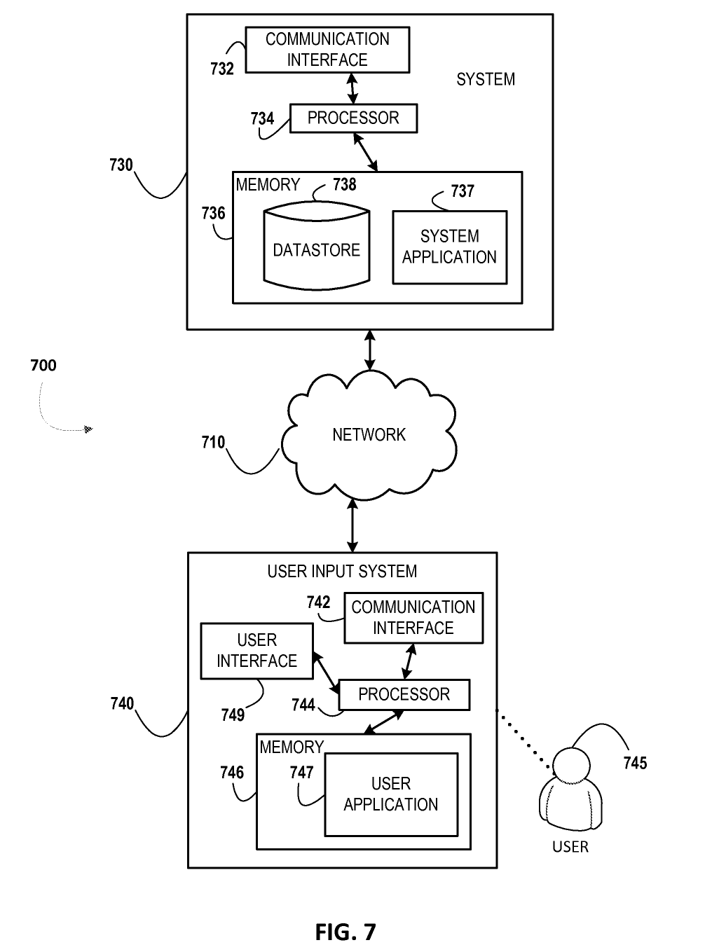

FIG. 7 presents a block diagram of the system environment 700 for implementing the process flow described in FIG. 1 in accordance with embodiments of the present invention. As illustrated, the system environment 700 includes a network 710, a system 730, and a user input system 740. Also shown in FIG. 7 is a user 745 of the user input system 740. The user input system 740 may be any type of computer system, such as but not limited to a desktop, laptop, mobile device (e.g., smartphone, personal digital assistant, or the like) as described herein. The user 745 may be a person who uses the user input system 740 to execute a user application 747. The user application 747 may be an application to communicate with the system 730, perform a transaction, input information onto a user interface presented on the user input system 740, or the like. The user application 747 and/or the system application 737 may incorporate one or more parts of any process flows described herein.

As shown in FIG. 7, the system 730, and the user input system 740 are each operatively and selectively connected to the network 710, which may include one or more separate networks. In addition, the network 710 may include a telecommunication network, local area network (LAN), a wide area network (WAN), and/or a global area network (GAN), such as the Internet. It will also be understood that the network 710 may be secure and/or unsecure and may also include wireless and/or wireline and/or optical interconnection technology.

The user input system 740 may include any computer system that can be configured to perform any one or more of the functions of the user input system 740 described and/or contemplated herein. For example, the user 745 may use the user input system 740 to transmit and/or receive information or commands to and from the system 730. In some embodiments, for example, the user input system 740 may include a personal computer system (e.g. a non-mobile or non-portable computing system, a motor vehicle, or the like), a mobile computing device, a personal digital assistant, a mobile phone, a tablet computing device, a network device, and/or the like. As illustrated in FIG. 7, in accordance with some embodiments of the present invention, the user input system 740 includes a communication interface 742, a processor 744, a memory 746 having an user application 747 stored therein, and a user interface 749. In such embodiments, the communication interface 742 is operatively and selectively connected to the processor 744, which is operatively and selectively connected to the user interface 749 and the memory 746. In some embodiments, the user 745 may use the user application 747 to execute processes described with respect to the process flows described herein. Specifically, the user application 747 executes the process flow described in FIG. 1.

Each communication interface described herein, including the communication interface 742, generally includes hardware, and, in some instances, software, that enables the user input system 740, to transport, send, receive, and/or otherwise communicate information to and/or from the communication interface of one or more other systems on the network 710. For example, the communication interface 742 of the user input system 740 may include a wireless transceiver, modem, server, electrical connection, and/or other electronic device that operatively connects the user input system 740 to another system such as the system 730. The wireless transceiver may include a radio circuit to enable wireless transmission and reception of information.

Each processor described herein, including the processor 744, generally includes circuitry for implementing the audio, visual, and/or logic functions of the user input system 740. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 747 of the memory 746 of the user input system 740.

Each memory device described herein, including the memory 746 for storing the user application 747 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 7, the memory 746 includes the user application 747. The user application 747 may be associated with various features of the device identification program. In some embodiments, the user application 747 includes an interface for communicating with, navigating, controlling, configuring, and/or using the user input system 740. In some embodiments, the user application 747 includes computer-executable program code portions for instructing the processor 744 to perform one or more of the functions of the user application 747 described and/or contemplated herein. In some embodiments, the user application 747 may include and/or use one or more network and/or system communication protocols.

Also shown in FIG. 7 is the user interface 749. In some embodiments, the user interface 749 includes one or more output devices, such as a display and/or speaker, for presenting information to the user 745. In some embodiments, the user interface 749 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user 745. In some embodiments, the user interface 749 includes the input and display devices of a mobile device, which are operable to receive and display information.

FIG. 7 also illustrates a system 730, in accordance with an embodiment of the present invention. The system 730 may refer to the “apparatus” described herein. The system 730 may include any computerized apparatus that can be configured to perform any one or more of the functions of the system 730 described and/or contemplated herein. In accordance with some embodiments, for example, the system 730 may include a computer network, an engine, a platform, a server, a database system, a front end system, a back end system, a personal computer system, and/or the like. Therefore, the system 730 may be a server managed by the entity. The system 730 may be located at the facility associated with the entity or remotely from the facility associated with the entity. In some embodiments, such as the one illustrated in FIG. 7, the system 730 includes a communication interface 732, a processor 734, and a memory 736, which includes a system application 737 and a datastore 738 stored therein. As shown, the communication interface 732 is operatively and selectively connected to the processor 734, which is operatively and selectively connected to the memory 736.

It will be understood that the system application 737 may be configured to implement any one or more portions of the various user interfaces and/or process flow described herein. The system application 737 may interact with the user application 747. It will also be understood that, in some embodiments, the memory includes other applications. It will also be understood that, in some embodiments, the system application 737 is configured to communicate with the datastore 738, the user input system 740, or the like.

It will be further understood that, in some embodiments, the system application 737 includes computer-executable program code portions for instructing the processor 734 to perform any one or more of the functions of the system application 737 described and/or contemplated herein. In some embodiments, the system application 737 may include and/or use one or more network and/or system communication protocols.

In addition to the system application 737, the memory 736 also includes the datastore 738. As used herein, the datastore 738 may be one or more distinct and/or remote datastores. In some embodiments, the datastore 738 is not located within the system and is instead located remotely from the system. In some embodiments, the datastore 738 stores information or data described herein. For example, the datastore 738 may store information associated with the user's account.

It will be understood that the datastore 738 may include any one or more storage devices, including, but not limited to, datastores, databases, and/or any of the other storage devices typically associated with a computer system. It will also be understood that the datastore 738 may store information in any known way, such as, for example, by using one or more computer codes and/or languages, alphanumeric character strings, data sets, figures, tables, charts, links, documents, and/or the like. Further, in some embodiments, the datastore 738 may include information associated with one or more applications, such as, for example, the system application 737. It will also be understood that, in some embodiments, the datastore 738 provides a substantially real-time representation of the information stored therein, so that, for example, when the processor 734 accesses the datastore 738, the information stored therein is current or substantially current.

It will be understood that the embodiment of the system environment illustrated in FIG. 7 is exemplary and that other embodiments may vary. As another example, in some embodiments, the system 730 includes more, less, or different components. As another example, in some embodiments, some or all of the portions of the system environment 700 may be combined into a single portion. Likewise, in some embodiments, some or all of the portions of the system 730 may be separated into two or more distinct portions.

In addition, the various portions of the system environment 700 may be maintained for and/or by the same or separate parties. It will also be understood that the system 730 may include and/or implement any embodiment of the present invention described and/or contemplated herein. For example, in some embodiments, the system 730 is configured to implement any one or more of the embodiments of the process flows described and/or contemplated herein in connection any process flow described herein. Additionally, the system 730 or the user input system 740 is configured to initiate presentation of any of the user interfaces described herein.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for electronically processing a customer request, the apparatus comprising:
a memory;
a processor; and
a module stored in memory, executable by the processor, and configured to:
initiate presentation of a first interface prompting a first user to input information associated with a customer request, wherein the information associated with the customer request includes at least a portion of a customer identification number, wherein the customer identification number is associated with a customer;
submit the customer request into a queue for display to a second user, wherein the customer identification number is masked;
initiate presentation of a second interface to the second user, wherein the second interface displays the information associated with the customer request, wherein the information associated with the customer request is editable;
process the customer request, wherein processing the customer request comprises at least one of executing or denying the customer request; and
transmit a first user message to the first user, in response to processing the customer request, wherein the first user message includes a status associated with the customer request.

2. The apparatus of claim 1, wherein the customer identification number comprises an account number associated with a financial account.

3. The apparatus of claim 2, wherein the financial account comprises at least one of a checking account, a savings account, or an investment account.

4. The apparatus of claim 1, wherein the customer request comprises at least one of a request for a replacement bank card, a request for opening a processing closure (PC) account, a report on a non-working automatic teller machine (ATM), or a financial data entry system (FDES) request.

5. The apparatus of claim 1, wherein the portion of the customer identification number includes the last four digits of the customer identification number.

6. The apparatus of claim 1, wherein the first user is an associate associated with the entity.

7. The apparatus of claim 1, wherein the second user is a front line manager (FLM) associated with the entity.

8. The apparatus of claim 1, wherein the queue distributes the customer request to a next available front line manager (FLM).

9. The apparatus of claim 1, wherein the customer identification number is masked by replacing each digit of the customer identification number with a zero.

10. The apparatus of claim 1, wherein processing the customer request comprises generating a record of the customer request as well as information associated with the customer request.

11. The apparatus of claim 1, wherein in addition to submitting the customer request into the queue the module executable by the processor is further configured to:
generating and transmitting a second user message to a second apparatus associated with the second user, wherein the second user message includes at least one of an associate name, a front line manager (FLM) name, a request type, a date and time of submission, a request identification number, or instructions associated with processing the customer request.

12. The apparatus of claim 1, wherein transmitting the first user message to the first user comprises generating and transmitting the first user message, wherein the first user message includes at least one of an associate name, a front line manager (FLM) name, a request type, a date and time of submission, a request identification number, a reason for denial, or instructions associated with processing the customer request.

13. The apparatus of claim 1 further comprises a portal that enables users to access, view, edit, modify, delete, add, append, store, save, upload, download, and share information associated with the customer request.

14. The apparatus of claim 13, wherein user authentication is required to access the portal.

15. The apparatus of claim 1, wherein processing the customer request further comprises tracking the customer request and providing analytics based on processing the customer request.

16. A computer program product for electronically processing a customer request, the computer program product comprising a non-transitory computer-readable medium comprising code causing a computer to:
initiate presentation of a first interface prompting a first user to input information associated with a customer request, wherein the information associated with the customer request includes at least a portion of a customer identification number, wherein the customer identification number is associated with a customer;
submit the customer request into a queue for display to a second user, wherein the customer identification number is masked;
initiate presentation of a second interface to the second user, wherein the second interface displays the information associated with the customer request, wherein the information associated with the customer request is editable;
process the customer request, wherein processing the customer request comprises at least one of executing or denying the customer request; and
transmit a first user message to the first user, in response to processing the customer request, wherein the first user message includes a status associated with the customer request.

17. The computer program product of claim 16, wherein the customer identification number comprises an account number associated with a financial account.

18. The computer program product of claim 16, wherein processing the customer request further comprises tracking the customer request and providing analytics based on processing the customer request.

19. A method for electronically processing a customer request, the method comprising:
initiating, by a processor, presentation of a first interface prompting a first user to input information associated with a customer request, wherein the information associated with the customer request includes at least a portion of a customer identification number, wherein the customer identification number is associated with a customer;
submitting, by the processor, the customer request into a queue for display to a second user, wherein the customer identification number is masked;
initiating, by the processor, presentation of a second interface to the second user, wherein the second interface displays the information associated with the customer request, wherein the information associated with the customer request is editable;
processing, by the processor, the customer request, wherein processing the customer request comprises at least one of executing or denying the customer request; and
transmitting, by the processor, a first user message to the first user, in response to processing the customer request, wherein the first user message includes a status associated with the customer request.

20. The method of claim 19, wherein the customer identification number comprises an account number associated with a financial account.
